(19) United States
(12) Patent Application Publication
(10) Pub. No.: US 2006/0267527 A1
(43) Pub. Date: Nov. 30, 2006

(54) System, apparatus and method for driving permanent magnet electrical machine

(76) Inventors: Rahul Vijaykumar Khopkar, Lubbock, TX (US); Seyed Mohammad Madani, Mayaguez, PR (US); Masoud Hahaghajani, Houston, TX (US); Hamid A. Toliyat, College Station, TX (US)

Correspondence Address: Rahul V. Khopkar, 9 Royal Crest Drive, Apt. 5, Nashua, NH, 03060, US

(21) Appl. No.: 11/137,917

(22) Filed: May 26, 2005

(51) Int. Cl. H02P 7/06

(52) U.S. Cl. 318/254

(57) ABSTRACT

The present invention provides a system, apparatus and method for driving a permanent magnet (PM) machine supplied by a Current Source Inverter (CSI). A DC-DC voltage to current converter (chopper) with an inductor value inversely related to the operating frequency of the DC chopper for a given DC Link current ripple, acts as a current source for the CSI. The DC source for the DC-DC voltage to current converter can be from a DC power source or supply, or an AC power source or supply electrically connected to a rectifier/Pulse Width Modulated (PWM) rectifier.

This application claims the benefit of U.S. provision application Ser. No. 60/575,928. filed May 31. 2004. entitled “System Apparatus and Method for Driving Permanent Magnet Electric Machine,” the disclosure of which is incorporated herein by reference in its entirety for all purposes.

### FIELD OF THE INVENTION

The present invention relates in general to the field of electric motors and more particularly to a system, apparatus and method for driving permanent magnet electrical machines.

### BACKGROUND OF THE INVENTION

Brushless direct current (DC) motors (referred to as BLDC motors) are used in various applications. They produce more output power for a given frame size. The advantages of the BLDC motor come at the expense of increased complexity of the driver.

Driving a BLDC motor needs a controlled current source to inject rectangular current to the armature windings. This current control has been previously implemented using two different methods. The first method is shown in FIG. 1, which is a schematic diagram illustrating a conventional BLDC driver 100 with input current shaping in accordance with the prior art. The BLDC driver 100 includes an alternating current (AC) power source 102 electrically connected to a diode bridge rectifier 104 to provide a DC voltage, which feeds a voltage source inverter (VSI) 106. The VSI 106 then drives the BLDC motor 108. This particular VSI 106 uses a pulse-width modulated (PWM) current control. The winding current is controlled by hard switching the insulated gate bipolar transistors (IGBTs) 110 at a very high frequency. These IGBTs 110 require the use of large heat sinks. These switching operations cause switching loss in the IGBTs 110, reducing the driver efficiency as well as dissipating heat. Moreover, the cost of this BLDC driver 100 is increased because of the IGBT switches 110 and an expensive DC Link capacitor 112, which is inherently unreliable.

The second method is shown in FIG. 2, which is a schematic diagram illustrating a BLDC motor driver 200 using a big inductor L_{d} as a current source in accordance with the prior art. The BLDC motor driver 200 includes an alternating current (AC) power source 202 electrically connected to a thyristor bridge rectifier 204 to provide a DC voltage, which feeds a big inductor L_{d}. The big inductor L_{d} is connected in series with a Current Source Inverter (CSI) 206 to inject a constant current to the BLDC motor 208. The CSI 206 uses natural turn-off switching, thereby eliminating the heat sinks as well as the large DC Link capacitor 112 (FIG. 1). The big inductor L_{d} and a controlled rectifier 204 act as the current source. Since this method uses the low cost thyristors 210 instead of MOSFET/IGBT switches, this motor driver 200 has a lower cost than motor driver 100 (FIG. 1). However, this topology is not compact due to the use of a big inductor L_{d} (400%). The large value of the DC Link inductor L_{d} and the huge number of turns needed to achieve the necessary inductance causes huge resistive losses.

There is, therefore, a need for a system, apparatus and method for driving a permanent magnet (PM) motor that is low cost, rugged, highly efficient, reliable, short circuit immune, compact and lighter than conventional permanent magnet motor drivers.

### SUMMARY OF THE INVENTION

The present invention provides a novel permanent magnet (PM) motor driver that is low cost, rugged, highly efficient, reliable, short circuit immune, compact and lighter than conventional PM motor drivers. The motor driver topology of the present invention is ideal for residential and commercial applications, such as building air conditioning, appliances, etc. The present invention is fault tolerant due to its current regulated nature, where it can even withstand a solid short circuit at its output terminals. Moreover, the present invention provides a cost reduction of about 30% with respect to the commercially used IGBT-based systems (FIG. 1) and over 20% with respect to commercially used VSI-based systems (FIG. 2). Since all the switches used in the output three-phase inverter are current commutated, this motor driver has much lower switching losses than the conventional PWM motor driver.

The present invention replaces the controlled rectifier and large inductor or capacitor of the prior art (FIGS. 1 and 2) with a suitable DC-DC voltage to current converter (chopper) and a CSI. Switching the DC-DC voltage to current converter (chopper) at high frequencies makes it possible to use a much smaller DC Link inductor without increasing the current ripple. Moreover, for a given DC Link current ripple, the value of the DC Link inductor is approximately inversely related to the chopper switching frequency. Hence, it is possible to have the advantages of using a CSI as well as a smaller DC Link inductor without a corresponding increase in the heat sink and snubber requirements. Moreover, a CSI has negligible switching losses, and is therefore more efficient and reliable than a hard-switched Voltage Source Inverter. In addition, since the DC-DC converter has an inductor at its front-end, the input current drawn from the mains can be controlled to achieve almost unity power factor. The DC-DC converter also works like a buck/boost converter so that it is able to boost the supply voltage to the motor. All of these factors make the BLDC motor and, consequently, the driver of the present invention, more efficient and compact.

More specifically, the present invention provides a driver for a permanent magnet (PM) motor that includes a DC-DC voltage to current converter and a Silicon Controlled rectifier (SCR) based current source inverter that is electrically connected to the DC-DC voltage to current converter. The DC voltage supplied to the DC-DC voltage to current converter can be from either a DC power source or supply, or an AC power source or supply electrically connected to a rectifier. The PM motor is typically a brushless direct current (BLDC) motor.

In addition, the present invention provides a system for controlling a PM motor that includes a power supply or source and a PM motor controller electrically connected to the power supply and the PM motor. The PM motor controller includes a PM motor driver and a processor. The PM motor driver includes a DC-DC voltage to current converter electrically connected to the power supply and CSI electrically connected to the DC-DC voltage to current converter and the PM motor. The processor can be a microprocessor or a digital signal processor (DSP).

Moreover, the present invention provides a method for controlling a PM motor by receiving a DC voltage, converting the DC voltage into a DC current source, and distributing DC current from the DC current source to the PM motor using a CSI. The DC voltage can be provided by a DC power source or supply, or an AC power source or supply. Using an AC power source or supply will additionally require receiving an AC voltage and rectifying the AC voltage to provide a DC voltage.

Other features and advantages of the present invention will be apparent to those of ordinary skill in the art upon reference to the following detailed description taken in conjunction with the accompanying drawings.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts in which:

FIG. 1 is a schematic diagram illustrating a conventional BLDC driver with input current shaping in accordance with the prior art;

FIG. 2 is a schematic diagram illustrating a BLDC motor driver using inductor as a current source in accordance with the prior art;

FIG. 3 is a block diagram of a permanent magnet motor driver in accordance with the present invention;

FIG. 4 is a block diagram of a PM motor driver in accordance with the present invention;

FIG. 5 is a flowchart illustrating the operation of the PM motor driver in accordance with the present invention;

FIG. 6 is a schematic diagram illustrating a Buck supplied BLDC motor driver in accordance with one embodiment of the present invention;

FIG. 7 is a schematic diagram illustrating a Cuk supplied BLDC motor driver in accordance with one embodiment of the present invention;

FIG. 8 is an electrical model of a motor driver in accordance with one embodiment of the present invention;

FIG. 9 is an electrical model of a motor driver using a converter average model in accordance with one embodiment of the present invention;

FIG. 10 is a graph of a root locus of a Buck supplied BLDC motor in accordance with one embodiment of the present invention;

FIG. 11 is a control diagram of a closed loop model of a BLDC motor driver supplied by a Buck converter in accordance with one embodiment of the present invention;

FIG. 12 is an average model of a Buck supplied BLDC motor in accordance with another embodiment of the present invention;

FIG. 13 is a diagram illustrating a rectified back emf (due to the CSI) in accordance with one embodiment of the present invention;

FIG. 14 is a graph of the reference and measured speed for a Cuk supplied BLDC motor driver in accordance with one embodiment of the present invention;

FIG. 15 is a graph of a simulation showing motor phase current for a Cuk supplied CSI BLDC motor driver in accordance with one embodiment of the present invention;

FIG. 16 is a graph of a simulation showing motor phase current for a Buck supplied CSI BLDC motor driver in accordance with one embodiment of the present invention;

FIG. 17 is a graph of a simulation showing DC Link current for a Buck supplied CSI BLDC motor driver in accordance with one embodiment of the present invention;

FIG. 18 is a graph of a simulation showing motor phase current for a Buck supplied CSI BLDC motor driver in accordance with one embodiment of the present invention;

FIG. 19 is a graph showing back emfs, Hall Position Sensors and SCR gating in accordance with one embodiment of the present invention;

FIG. 20 is a graph showing Hall Position Sensors and rectified back emf in accordance with one embodiment of the present invention;

FIG. 21 is a graph showing Buck duty cycle and DC Link current (no load) in accordance with one embodiment of the present invention;

FIG. 22 is a graph showing Buck duty cycle and BLDC phase current (no load) in accordance with one embodiment of the present invention;

FIG. 23 is a graph showing Position & DC Link current (load T=0.4 Nm) in accordance with one embodiment of the present invention; and

FIG. 24 is a graph showing BLDC phase current (load T=0.4 Nm) in accordance with one embodiment of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention. It should be understood that the principles and applications disclosed herein can be applied to a wide range of permanent magnet (PM) motor drivers.

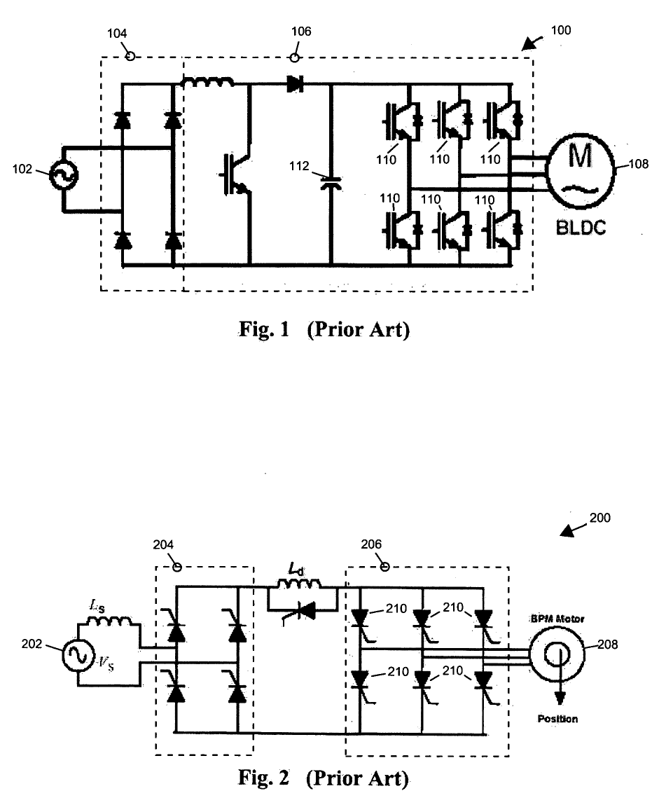

The present invention provides a novel permanent magnet (PM) motor driver that is low cost, rugged, highly efficient, reliable, short circuit immune, compact and lighter than conventional PM motor drivers. The motor driver topology of the present invention is ideal for residential and commercial applications, such as building air conditioning, appliances, etc. The present invention is fault tolerant due to its current regulated nature, where it can even withstand a solid short circuit at its output terminals. Moreover, the present invention provides a cost reduction of about 30% with respect to the commercially used IGBT-based systems (FIG. 1) and over 20% with respect to commercially used VSI-based systems (FIG. 2). Since all the switches used in the output three-phase inverter are current commutated, this driver has much lower switching losses than the conventional PWM driver.

The present invention replaces the controlled rectifier and large inductor or capacitor of the prior art (FIGS. 1 and 2) with a suitable DC-DC voltage to current converter (chopper) and a CSI. Switching the chopper at high frequencies makes it possible to use a much smaller DC Link inductor without increasing the current ripple. Hence, it is possible to have the advantages of using a CSI as well as a smaller DC Link inductor without a corresponding increase in the heat sink and snubber requirements. Moreover, the use of a SCR based CSI has negligible switching losses, and is therefore more efficient and reliable than an IGBT-based inverter. In addition, since the DC-DC converter has an inductor at its front-end, the input current drawn from the mains can be controlled to achieve almost an unity power factor. The DC-DC converter also works like a buck/boost converter so that it is able to boost the supply voltage to the motor. All of these factors make the BLDC motor and, consequently, the driver of the present invention, more efficient and compact.

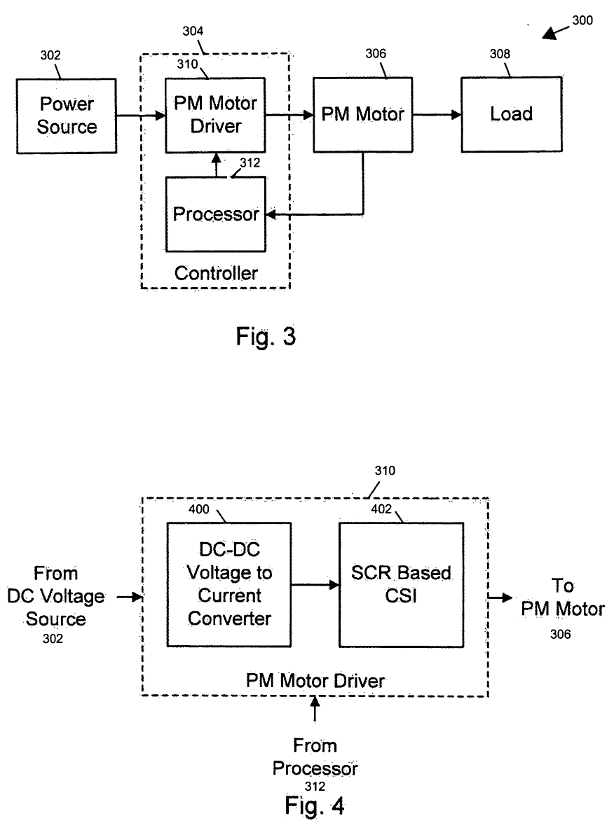

Now, referring to FIG. 3, a block diagram of a PM motor driver 300 in accordance with the present invention is shown. The PM motor driver 300 includes a power supply or source 302 and a PM motor controller 304 electrically connected to the power supply 304 and the PM motor 306. In operation, the PM motor is connected to and drives the load 308. The PM motor controller 304 includes a PM motor driver 310 and a processor 312. As shown in FIGS. 3 and 4, the PM motor driver 310 includes a DC-DC voltage to current converter 400 electrically connected to the power supply 302 and a SCR based CSI 402 electrically connected to the DC-DC voltage to current converter 400 and the PM motor 306. The processor 312 can be a microprocessor or a digital signal processor (DSP).

Referring now to FIG. 4, a block diagram of a PM motor driver 310 in accordance with the present invention is shown. The driver 310 for the PM motor 306 includes a DC-DC voltage to current converter 400 and a silicon controlled rectifier (SCR) based CSI 402 electrically connected to the DC-DC voltage to current converter 400. The DC voltage 302 supplied to the DC-DC voltage to current converter 400 can be from a DC power source or supply, or an AC power source or supply electrically connected to a rectifier. The DC-DC voltage to current converter 400 can be a Buck DC-DC Converter or a Cuk DC-DC Converter. The PM motor 306 is typically a brushless direct current (BLDC) motor.

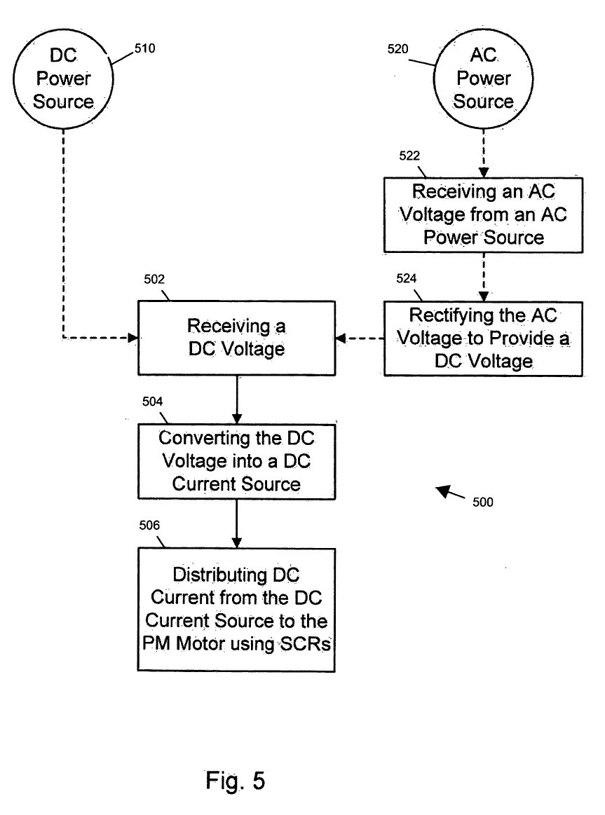

Now, referring to FIG. 5, a flowchart 500 illustrating the operation of the PM motor driver in accordance with the present invention is shown. The PM motor is controlled in accordance with the method 500 by receiving a DC voltage in block 502, converting the DC voltage into a DC current source in block 504, and distributing DC current from the DC current source to the PM motor using SCRs in block 506. The DC voltage can be provided by a DC power source or supply 510, or an AC power source or supply 520 as indicted by the dashed lines. Using an AC power source or supply 520 will additionally require receiving an AC voltage in block 522 and rectifying the AC voltage to provide a DC voltage in block 524.

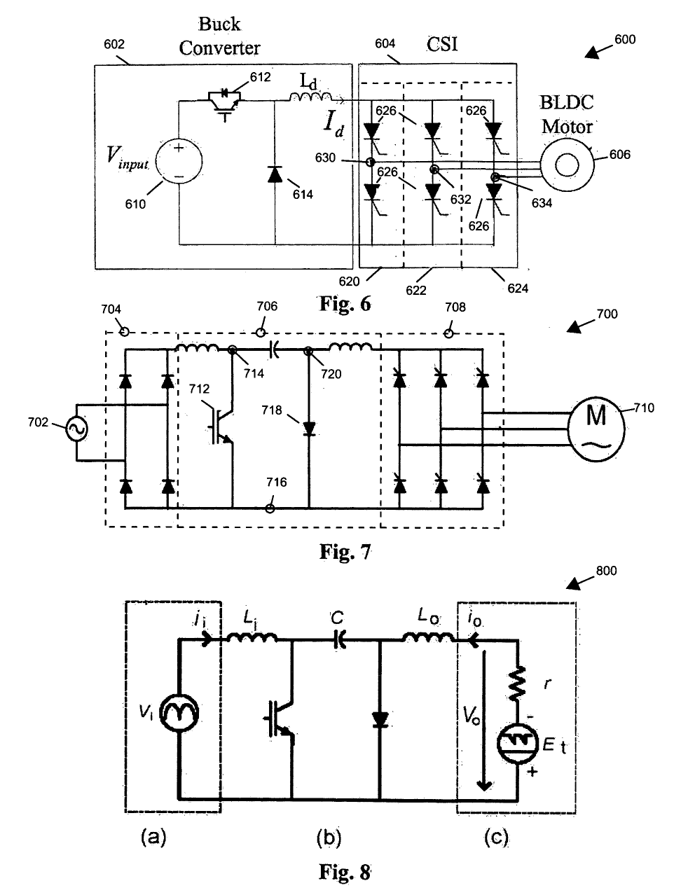

Referring now to FIG. 6, a schematic diagram illustrating a Buck supplied BLDC motor driver 600 in accordance with one embodiment of the present invention is shown. Motor driver 600 includes a Buck DC-DC voltage to current converter 602 electrically connected to a SCR based CSI 604 that drives the BLDC motor 606. The Buck DC-DC voltage to current converter 602 includes a DC voltage source 610 electrically connected in series with an IGBT switch 612. A diode 614 is electrically connected in parallel to the DC voltage source 610 and IGBT switch 612. A DC Link inductor L_{d} is electrically connected in series with the previously described circuit (610, 612 and 614) to provide current to the SCR based CSI 604. The SCR based CSI 604 includes three half-bridge assemblies 620, 622 and 624, each assembly having two thyristor switches 626. The thyristor switches 626 are connected in series with nodes 630, 632 and 634 for respective half-bridge assemblies 620, 622 and 624. This topology controls the current fed to the SCR base CSI 604, thereby enabling speed control.

Now, referring to FIG. 7, a schematic diagram illustrating a Cuk supplied BLDC motor driver 700 in accordance with one embodiment of the present invention is shown. The motor driver 700 includes an AC power source 702 electrically connected to a diode bridge rectifier 704. A Cuk DC-DC voltage to current converter 706 is electrically connected to the diode bridge rectifier 704 and a SCR based CSI 708. The SCR based CSI 708 drives BLDC motor 710. The Cuk DC-DC voltage to current converter 706 includes a series connected inductor Lᵢ, capacitor C and inductor Lₒ. A transistor switch 712 is electrically connected between node 714 and the negative line 716. Node 714 is between inductor Lᵢ and capacitor C. A diode 718 is electrically connected between node 720 and the negative line 716. Node 720 is between capacitor C and inductor L₀. The SCR based CSI 708 is similar to the SCR based CSI 604 described in reference to FIG. 6.

Referring now to FIG. 8, an electrical model 800 of the Cuk supplied BLDC motor driver 700 (FIG. 7) in accordance with one embodiment of the present invention is shown. The Cuk supplied BLDC driver 800 consists of three parts: (a) a diode bridge rectifier; (b) a dc-dc voltage to current converter; and (c) a SCR based inverter and the BLDC motor. The diode bridge and the sinusoidal ac source are modeled by a rectified sinusoidal ac voltage source Vᵢ. The SCR based inverter together with the BLDC motor is modeled by a voltage source eₜ:
eₜ=2eₚₕ+v_{c}=2kω+v_{c} (1)
where:
eₚₕ: back emf voltage induced in each conducting motor phase winding (V)
v_{c}: voltage ripple due to commutation (V)
ω: rotor angular speed (rad/sec)
   The voltage ripple v_{c} is due to the current commutation in the SCR based inverter. The shape, the peak value and the frequency of this ripple depend on the load current, the motor leakage inductance and the motor speed.

Now referring to FIG. 9, an electrical model 900 of a motor driver using a converter average model in accordance with one embodiment of the present invention is shown. The DC-DC voltage to current converter behaves like an adjustable DC current source, which supplies the motor via the inverter. This converter is a modification of the Cuk converter. In this converter, the average output current is regulated by controlling the duty cycle of the switch (tₒₙ and t_{off}). A constant switching frequency of ƒₛ=1/Tₛ is employed to provide:
Tₛ=tₒₙ+t_{off} (2)

To analyze the converter operation at steady state, it is assumed that:
(i) Both inductors are very large and their currents are constant.
(ii) The capacitor is very large and the voltage across it is constant.
(iii) For the duty ratio D, the switch is closed for DT and open for (1-D)T.
(iv) The switch and the diode are ideal.

At the steady state, the average inductor voltages V_{L}_{ᵢ} and V_{L}_{ₒ} are zero.
V_{c}=Vᵢ+Vₒ (3)

For the time duration (1-D)Tₛ, where the switch is on, the diode is off and the current in the capacitor is given by:
(i_{c})ₒₙ=−iₒ (4)

For the time duration DTₛ, the switch is off, the diode is on and the current in the capacitor is:
(i_{c})_{off}=iᵢ (5)

For periodic operation, the average capacitor current is zero:

$$\frac{{i}_{o}}{{i}_{i}} = \frac{1 - D}{D} \qquad ( 6 )$$

The ripple in C can be estimated by computing the changes in v_{c} over the interval when the switch is open, i.e., (1-D)Tₛ. Assuming the inductor current in Lᵢ to be constant at its average value Iᵢ,

$$Δ {v}_{c} \approx \frac{1}{C} {\int }_{{DT}_{s}}^{{T}_{s}} {I}_{i} ⅆ t = \frac{{I}_{i}}{C} ( 1 - D ) T = \frac{{I}_{i} ( 1 - D )}{{C}_{f}} \qquad ( 7 )$$

The change in the inductor (Li) current can be estimated based on its voltage drop (VLᵢ=Vᵢ) while the switch is closed as follows:

$$Δ {i}_{{L}_{1}} = Δ {i}_{i} \approx \frac{1}{{L}_{i}} {\int }_{0}^{{DT}_{s}} {V}_{i} ⅆ t = \frac{{V}_{i} {DT}_{s}}{{L}_{i}} = \frac{{V}_{i} D}{{L}_{i} f} \qquad ( 8 )$$

When the switch is open, the voltage across L₂ is Vₒ; therefore, the current change in Lₒ is:

$$Δ {i}_{{L}_{o}} = Δ {i}_{o} \approx \frac{1}{{L}_{o}} {\int }_{{DT}_{s}}^{{T}_{s}} {V}_{o} ⅆ t = \frac{{V}_{o} ( 1 - D ) {T}_{s}}{{L}_{o}} = \frac{{V}_{o} ( 1 - D )}{{L}_{o} f} \qquad ( 9 )$$

For designing a controller, the transient behavior of the proposed driver must be analyzed. Therefore, the small signal model of the driver system needs to be obtained. The DC-DC converter in FIG. 9 is shown by its average model. The switch is replaced by a dependent current source i_{T} and the diode is replaced by a dependent voltage source V_{d} as follows:
_{T}=d(iᵢ+iₒ) (10)
V_{d}=d·v_{c}=d(vᵢ+vₒ) (11)
where:
vₒ=Vₒ+\tilde{v}ₒ (12)
iₒ=Iₒ+ĩₒ (13)
iᵢ=Iᵢ+ĩᵢ (14)
d=D+\tilde{d} (15)

The steady state or dc term is represented by the upper case letter, the “~” (tilde) quantity represents the ac term.
i_{T}=(D+\tilde{d})(Iᵢ+ĩᵢ+Iₒ+ĩₒ)≅DIᵢ+(Iᵢ+Iₒ)\tilde{d}+D(ĩᵢ+ĩₒ) (16)
ĩ_{T=(}Iᵢ+Iₒ)\tilde{d}+D(ĩᵢ+ĩₒ) (17)

In the same way, from (11), (12), and (15) the ac value of v_{D} is derived as follows:
\tilde{v}_{D}=(Vᵢ+Vₒ)\tilde{d}+D(\tilde{v}ᵢ+\tilde{v}ₒ) (18)

The ac component of vₒ is:
\tilde{v}ₒ=2k\tilde{ω}+v_{c} (19)

By replacing the ac quantities in FIG. 8, the small signal model of the driver system is achieved.

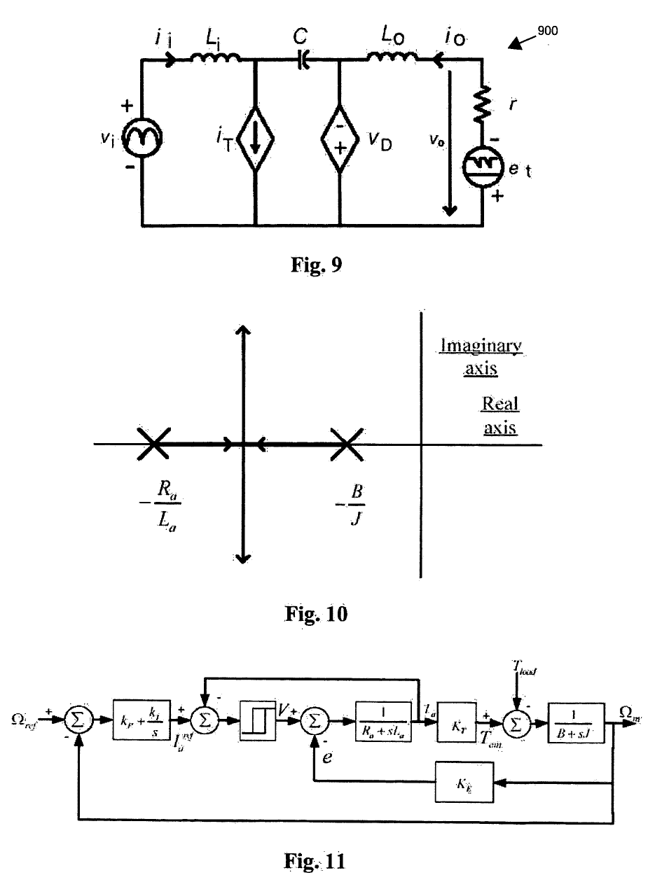

With respect to the Buck supplied BLDC motor, FIG. 10 shows a graph of a root locus of a Buck supplied BLDC motor in accordance with one embodiment of the present invention. This graph shows that the given transfer function is stable. FIG. 11 is a control diagram of a closed loop model of a BLDC motor driver supplied by a Buck converter in accordance with one embodiment of the present invention. The speed of the BLDC motor (closed loop) shown in FIG. 11 as a function of the input supply voltage is given by equation 20:

$$\frac{Ω ( s )}{V ( s )} = \frac{\frac{{K}_{T}}{{JL}_{a}}}{{s}^{2} + ( \frac{{JR}_{a} + {BL}_{a}}{{JL}_{a}} ) s + ( \frac{{BR}_{a} + {K}_{T} {K}_{E}}{{JL}_{a}} )} \qquad ( 20 )$$

where the motor parameters (Table I) are [7]:
input V DV=, D being the duty cycle of the switch (21)
K_{E}=back emf constant (22)
K_{T}=torque constant (23)
L_{α}=phase inductance of the BLDC (24)
R_{α}=armature resistance of the BLDC (25)
J=moment of inertia (26)
B=damping coefficient (27)
Ω=rotor speed (28)

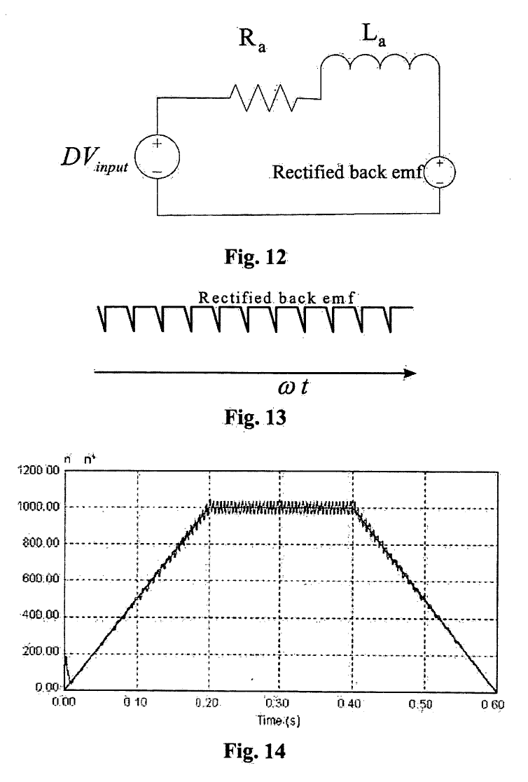

FIG. 12 is an average model of a Buck supplied BLDC motor in accordance with another embodiment of the present invention. The supply of the Buck can be considered proportional to the duty cycle of the switch and the BLDC motor plus the CSI as a DC motor with back emf, as shown in FIG. 13.

Simulations were performed for a Cuk supplied BLDC motor driver in accordance with one embodiment of the present invention. The simulation results were obtained using a simulation package PSIM. The parameters of the motor used in simulation and experiments are shown in the Table below:

| Output power = 288 W | Input Voltage = 50 V |
|---|---|
| Cuk Converter Parameters | Buck Converter Parameters |
| Lₗ = 2 mH | L =2mH |
| (8% of base value) | (8% of base value) |
| Lₒ = 5 mH | |
| (20.8% of base value)) | |
| C = 75 μH | |

BLDC Motor Parameters

| | |
|---|---|
| No. of poles = 4 | Self inductance: L-M = 1 mH |
| Conduction Pulse | Line-to-line back |
| width = 120° | emf = 24 V/1000 rpm |
| Phase current leading | Mech. Time Constant = 0.1 Sec |
| angle = 10° | |

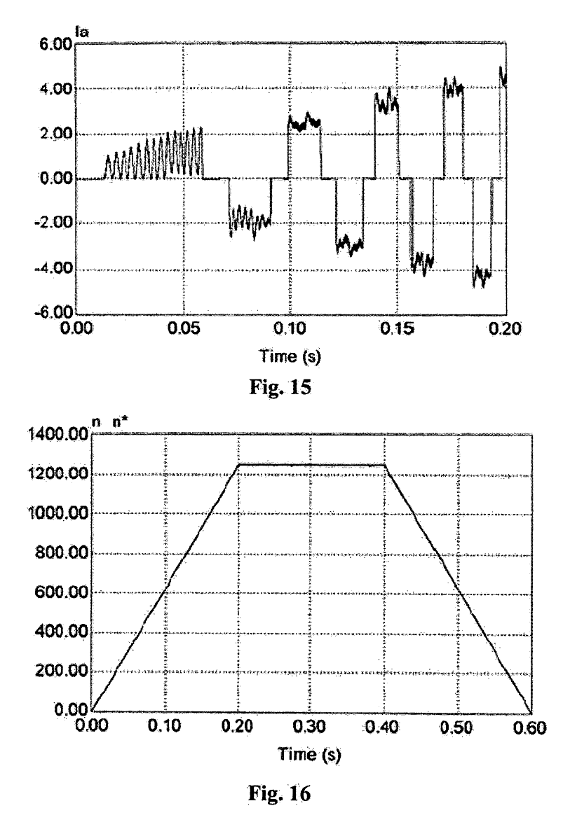

FIG. 14 is a graph of the reference and measured speed for Cuk supplied BLDC motor driver. FIG. 15 is a graph of a simulation showing motor phase current for a Cuk supplied CSI BLDC motor driver.

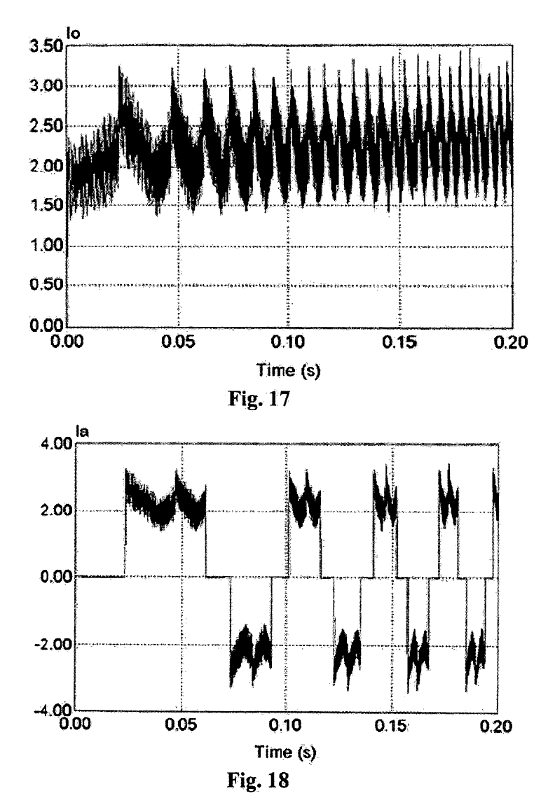

FIG. 16 is a graph of a simulation showing motor phase current for a Buck supplied CSI BLDC motor driver. FIG. 17 is a graph of a simulation showing DC Link current for a Buck supplied CSI BLDC motor driver. FIG. 18 is a graph of a simulation showing motor phase current for a Buck supplied CSI BLDC motor driver.

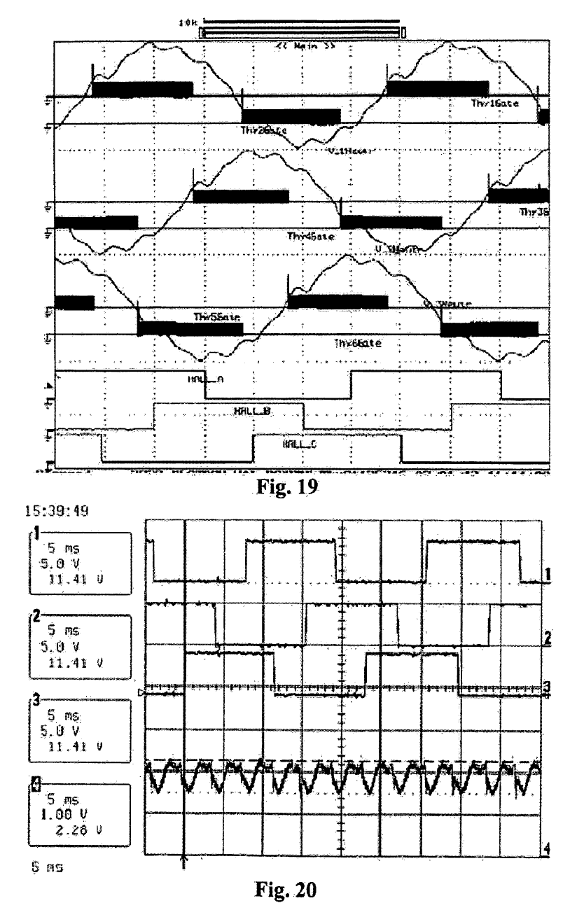

The implementation was carried out using a TMS320F243 based controller board. FIG. 19 shows the thyristor gating waveforms of the CSI as a function of the motor phase-to-virtual neutral back emfs and the Hall Position Sensors. Note the absence of trapezoidal back emf waveform due to the absence of the third harmonic that contributes to the formation of the trapezoidal back emf waveform. FIG. 20 shows the rectified back emf corresponding to the model used in FIG. 12.

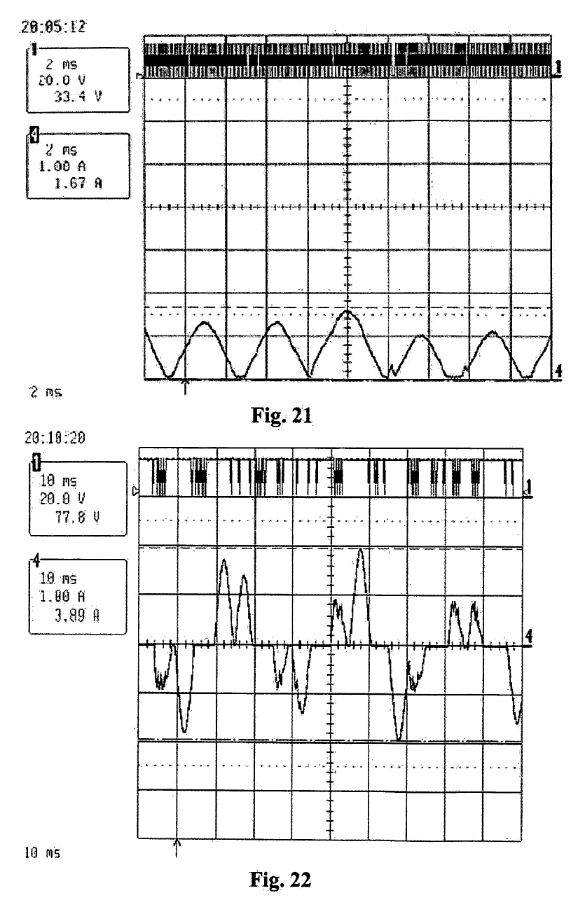

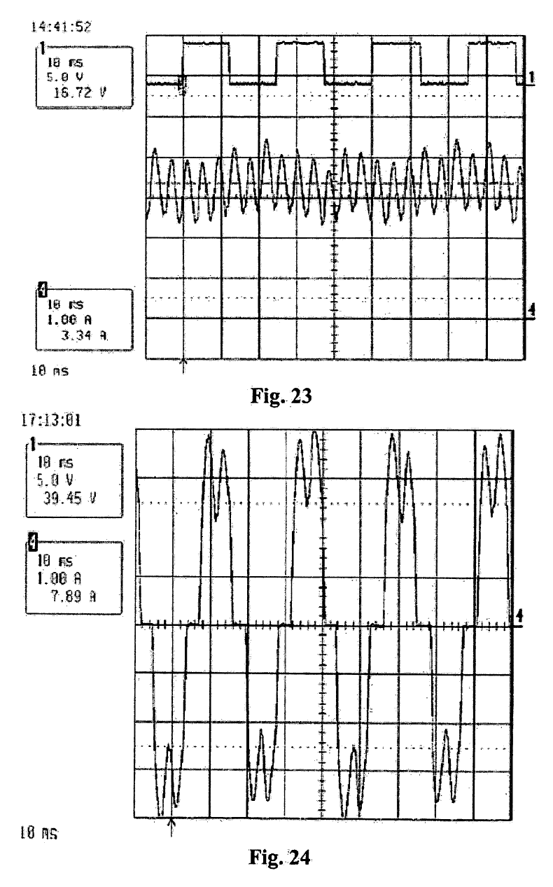

The DC Link current for the Buck supplied driver and the phase current for the motor (under no load) is illustrated in FIGS. 21 and 22 respectively. FIGS. 23 and 24 show the DC Link current and the phase current under a load of 0.4 Nm. By comparing FIG. 21 with FIG. 23 and FIG. 22 with FIG. 24, one can conclude that the current ripple is much greater under no load conditions.

The results illustrate the working of the BLDC driver using a Buck supplied CSI in accordance with the present invention. A current ripple of 30% has to be taken into account while considering the applications of the proposed driver. As shown in the following Tables, the reduction in cost is approximately 30% for a Cuk supplied BLDC driver and 22% for a Buck supplied BLDC driver.

Cost of proposed Cuk supplied topology compared
with conventional topology

| | Proposed Cuk | | Conventional | |
|---|---|---|---|---|
| | Topology | | Converter | |
| Components | Quantities | $ | Quantities | $ |
| IGBT | 1 | 0.75 | 6 | 4.50 |
| SCR | 6 | 1.50 | — | — |
| Inductor | 2 (few mH) | 2.00 | 1 (few mH) | 1.00 |
| Fast Recovery | 1 | 0.45 | 1 | 0.45 |
| Diode | | | | |
| Rectifier | 1 | 0.20 | 1 | 0.20 |
| Heat Sink | 1 | 1.00 | 7 | 3.50 |
| for IGBT's | | | | |
| Capacitor | 1 (0.1 mF) | 1.00 | 1 (about mF) | 4.90 |
| Gate driver | | 4.00 | | 3.00 |
| PCB, DSP, | | 4.85 | | 4.85 |
| Op-amps, etc. | | | | |
| Total | | $15.75 | | $22.40 |
| material cost | | | | |

| | | |
|---|---|---|
| Cost reduction | 29.6% | 0 |

Cost of proposed Buck supplied topology compared
with conventional topology

| | Proposed Buck Topology | | Conventional Converter | |
|---|---|---|---|---|
| Components | Quantities | $ | Quantities | $ |
| IGBT | 1 | 0.75 | 6 | 4.50 |
| SCR | 6 | 1.50 | — | — |
| Inductor | 1 (few mH) | 1.00 | 1 (few mH) | 1.00 |
| Fast Recovery | 1 | 0.45 | 1 | 0.45 |
| Diode | | | | |
| Heat Sink | 1 | 1.00 | 7 | 3.50 |
| for IGBT's | | | | |
| Gate driver | | 4.00 | | 3.00 |
| PCB, DSP, | | 4.85 | | 4.85 |
| Op-amps, etc. | | | | |
| Total material cost | | $13.55 | | $17.30 |

| | | |
|---|---|---|
| Cost reduction | 21.6% | 0 |

Although particular embodiments of the present invention have been described in detail, it will be understood by those skilled in the art that various modifications can be made therein without departing from the spirit and scope of the invention as set forth in the appended claims. Moreover, other programs or systems can be created or modified to implement the methods of the present invention. As a result, it is not intended that the present invention be limited to the particular system, apparatus and methods shown in FIGS. 1 through 24. The PM or the BLDC motor represents a Generalized Synchronous Machine/Motor and as such the above claims are valid for any Synchronous Machine or other Current Source Inverter supplied Machine/Motor Driver that has its current controlled by either a Chopper or a DC-DC Converter.

What is claimed is:

1. A driver for a permanent magnet (PM) machine comprising:
a DC-DC voltage to current converter (chopper)
with an inductor value inversely related to the operating frequency of the DC chopper for a given DC Link current ripple; and
Current Source Inverter (CSI) being supplied with a DC Link current by the DC-DC voltage to current converter (chopper).

2. (canceled)

3. The driver as recited in claim 1, wherein the DC-DC voltage to current converter (chopper) is a Buck DC-DC Converter (chopper) with an inductor value inversely related to the operating frequency of the DC chopper for a given DC Link current ripple.

4. The driver as recited in claim 1, wherein the DC-DC voltage to current converter (chopper) is a Cuk DC-DC Converter (chopper).

5. (canceled)

6. The driver as recited in claim 1, wherein the machine is a Brushless Direct Current (BLDC) machine.

7-14. (canceled)

15. A method for controlling a permanent magnet (PM) machine comprising the steps of:
receiving a DC voltage;
converting the DC voltage into a DC current source (or controlling the current supplied to the current source inverter (CSI)) using a DC-DC voltage to current converter (chopper);
distributing DC current from the DC current source to the machine using Current Source Inverter (CSI).

16. The method as recited in claim 15 comprising:
receiving an AC voltage; and
rectifying the AC voltage to provide a DC voltage;
converting the DC voltage into a DC current source (or controlling the current supplied to the current source inverter (CSI)) using a DC-DC voltage to current converter (chopper);
distributing the DC current from the DC current source to the machine using a Current Source Inverter (CSI).

17-20. (canceled)
